(19) United States
(12) Patent Application Publication
(10) Pub. No.: US 2002/0066464 A1
(43) Pub. Date: Jun. 6, 2002

(54) Processing a workpiece using ozone and sonic energy

(75) Inventor: Eric Bergman, Kalispell, MT (US)

Correspondence Address: LYON & LYON LLP, 633 WEST FIFTH STREET, SUITE 4700, LOS ANGELES, CA, 90071, US

(73) Assignee: Semitool, Inc.

(21) Appl. No.: 10/051,860

(22) Filed: Jan. 16, 2002

Related U.S. Application Data
(63) Continuation-in-part of application No. 09/621,028, filed on Jul. 21, 2000.
Application No. 09/621,028 is a continuation-in-part of application No. PCT/US99/08516, filed on Apr. 16, 1999.
Application No. PCT/US99/08516 is a continuation-in-part of application No. 09/061,318, filed on Apr. 16, 1998, now abandoned.
(63) Continuation-in-part of application No. 09/811,925, filed on Mar. 19, 2001.
Application No. 09/811,925 is a continuation of application No. 08/853,649, filed on May 9, 1997.
(63) Continuation-in-part of application No. 09/677,925, filed on Oct. 3, 2000.
Application No. 09/677,925 is a division of application No. 09/061,318, filed on Apr. 16, 1998, now abandoned.

(51) Int. Cl. B08B 3/12

(52) U.S. Cl. 134/1; 134/36; 134/102.1; 134/30; 134/28; 134/107; 134/186; 134/95.2; 134/95.3

(57) ABSTRACT

An apparatus for processing a semi-conductor wafer or similar workpiece has one or more liquid outlets for applying a heated process liquid to the wafer within a process chamber. Ozone gas is provided into the chamber directly, or via the processed liquid. Sonic energy is introduced to the workpiece through a layer of liquid. In an alternative design, the wafers are immersed in heated process liquid, and an ozone atmosphere is provided above the liquid. The wafers are then lifted out of the liquid, or the liquid is alternatively drained off. The ozone gas/liquid interface passes down across the surfaces of the wafers.

This Application is a Continuation-in-Part of U.S. patent application Ser. No. 09/621,028, filed Jul. 21, 2000, and now pending, which is a Continuation-In-Part/U.S. National Phase of International Application No. PCT/US99/08516, filed Apr. 16, 1999, and now expired, which in turn is a Continuation-In-Part of U.S. patent application Ser. No. 09/061,318, filed Apr. 16, 1998, now abandoned. This application is also a Continuation-In-Part of U.S. patent application Ser. No. 09/811,925, filed Mar. 19, 2001, and now pending, which is a Continuation of U.S. patent application Ser. No. 08/853,649, filed May 7, 1997, now U.S. Pat. No. 6,240,933. This Application is also a Continuation-in-Part of U.S. patent application Ser. No. 09/677,925, filed Oct. 2, 2000, and now pending, which is a Division of U.S. patent application Ser. No. 09/061,318 filed Apr. 16, 1998, and now abandoned. The Applications referenced above are incorporated herein by reference.

### FIELD OF THE INVENTION

The field of the invention is cleaning and processing flat media, such as semiconductor material (e.g., silicon) wafers and similar flat articles (such as memory disks, photomasks, flat panel displays, CD glass, etc., collectively referred to here as workpieces, articles or wafers). Semiconductor devices are widely used in almost all consumer electronic products, such as telephones, computers, CD players, etc. as well as in communications, medical, industrial, military, and office products and equipment. Semiconductor devices are manufactured from semiconductor wafers. The cleaning of semiconductor wafers is often a critical step in the fabrication processes used to manufacture semiconductor devices. The components on wafers are often on the order of fractions of a micron. This makes the devices manufactured on the wafers highly susceptible to performance degradation or failure due to organic, particulates or metallic/ionic contamination.

In recent years, great improvements have been made in cleaning and processing semiconductor wafers and similar articles. See, for example, U.S. Pat. No. 6,273,108B1, incorporated herein by reference. These improved processes use different techniques for creating a thin, aqueous boundary layer on a wafer surface and promoting the diffusion of ozone through that boundary layer to react with the surface or with various films or contaminants on the surface. Enhancements to the process have included the use of chemical additives, including but not restricted to ammonium hydroxide, hydrochloric acid and hydrofluoric acid.

While the diffusion of ozone through an aqueous film on a wafer surface has proven effective for oxidation of the surface and various contaminants, the effectiveness of the process still has certain limitations. For example, with photoresist removal, it has been found that the bulk (>90%) of the photoresist can be readily removed, but the last 10% or so will require a removal time equal to the time required for the initial 90% removal. This is at least in part due to the fact that the ozone process does not fully oxidize all the carbon-carbon or carbon-hydrogen bonds in the photoresist matrix. Instead, only some bonds are oxidized, resulting in the removal of hydrocarbon chains of significant length. These chains are released from the photoresist surface and are flushed away by the exchange of liquid moving across the wafer surface. As the amount of photoresist on the surface is diminished, the statistical probability of removing hydrocarbon chains of any significant length is also reduced. In the end, the final residues of photoresist must be oxidized on the surface to complete the cleaning.

It has been found that chemical additives such as ammonium hydroxide can help with the removal of the final photo resist residues. This does not appear to be necessarily due to an increase in the oxidation rate. Rather, it appears to be due to the change in the zeta potential (the measure of attractive forces between surface contamination and the surface in a given environment) which promotes the release and removal of the hydrocarbon chains and residue from the wafer surface. Accordingly, there is a need for improved methods and systems for removing contaminants, particles or coatings more quickly and efficiently. There is also a need for methods and systems providing improved removal of particles and hydrocarbon residues more efficiently by promoting such removal without requiring complete oxidation.

### SUMMARY OF THE INVENTION

Sonic energy is used in combination with ozone to promote the detachment of hydrocarbon chains and particles from the surface to be cleaned. This more readily exposes a fresh surface, rendering it subject to chemical attack by ozone. It also reduces the need for a longer cleaning step since the final residues can be detached from the surface instead of having to be oxidized in-situ. Controlled spray and rpm speed may be used to define the boundary layer. Chemical additives may also be used. The process is useful for either a batch or a single wafer processing. The wafers may be oriented at any angle from horizontal to vertical, whether face up or down. Steam, high pressure, and electromagnetic illumination/radiation may also be used.

A source of sonic energy (such as a sonic transducer) is coupled to the surface to be cleaned, through direct contact, or through a energy conductor such as a quartz, silicon, metal or polymer material. The sonic energy source may alternatively be coupled or in sonic contact with the wafer surface through a fluid link, such as an aqueous solution delivered through the transducer housing or from a separate delivery port with the fluid flow directed at the wafer surface. The fluid link may also include a boundary layer of liquid. The sonic energy source may be a flat rectangular transducer, a transducer having a shaped focussing chamber to concentrate the sonic energy or a solid bridge to focus the energy. Processing takes place in an ozone environment. Ozone diffuses through a liquid layer on the wafer surface and chemically reacts at the surface. Ozone and the liquid may be delivered through the same or a separate port(s).

In an immersion system, an ozone atmosphere is created over top of a bath of liquid, either by bubbling ozone directly into the liquid or injecting ozone into the space above the liquid. Sonic energy is applied to the liquid. The gas/liquid interface is passed across the wafer surface either by lifting the wafers out of the bath or by draining the liquid. The wafers may then optionally be re-immersed or the tank level re-filled. The rapid transitioning sequence uses an ozone rich interface which moves across the wafer surface while energized with the sonic energy, preferably megasonic energy or impulses. At the same time, the ozone diffuses through the liquid film on the wafer surface. This diffusion allows the use of water at temperatures above ambient to promote reaction kinetics. The gas/liquid interface moves across the wafer surface while the bath of heated aqueous solution is energized with sonic energy in the presence of an ozone environment. The present methods are especially advantageous in removing photoresist.

The improvements obtained include: (1) Reduction in process time, rendering single-wafer processing more efficient and more competitive with batch processing; (2) Cleaner processing by supporting the removal of contaminants to a lower level than previously achievable; (3) The removal of hardened films such as ion implanted resist which are difficult to remove using the known ozone diffusion processes; (4) Reduction in manufacturing waste products and adverse environmental factors by reducing the use of amount of water, ozone and chemicals needed in processing workpieces, by reducing processing times.

The invention resides as well in subcombinations of the features and steps described.

### BRIEF DESCRIPTION OF THE DRAWINGS

FIG. 1 is a schematic illustration of a system for performing preferred methods of cleaning or processing work pieces;

FIG. 2 is a schematically illustrated enlarged side view of a sonic transducer assembly for use in the system of FIG. 1;

FIG. 3 is a schematically illustrated alternative sonic transducer assembly for use in the system shown in FIG. 1; and

FIG. 4 is a schematic illustration of an alternative system for processing single wafers or batches of wafers using liquid immersion.

### DETAILED DESCRIPTION OF THE DRAWINGS

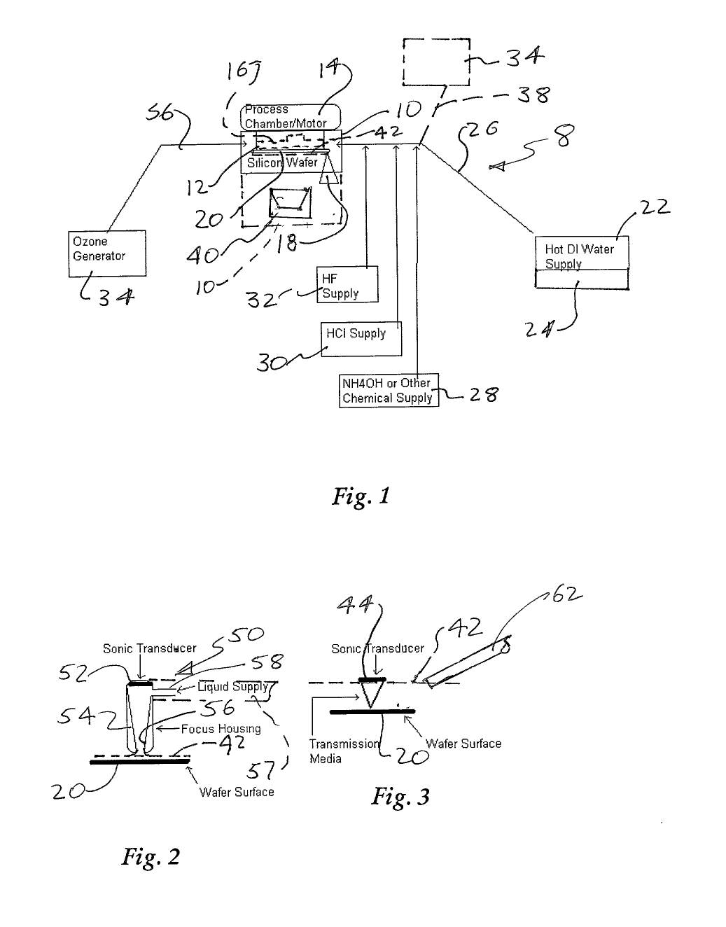

As shown in FIG. 1, in a single wafer processing system 8, a wafer or workpiece 20 is supported or held on or in a workpiece holder 12 within a process chamber 10. A motor 14 is optionally provided and connected to the workpiece holder 12, to spin the workpiece 20 within the chamber 10. A sonic transducer 16, shown in dotted lines in FIG. 1, such as a megasonic or ultrasonic transducer, is provided within the chamber 14, to introduce sonic energy to the workpiece 20.

As described, for example, in U.S. Pat. No. 6,273,108B1, the chamber 10 is supplied with ozone from an ozone generator 34. The ozone may be delivered into the process chamber 10 as a dry gas through an ozone gas supply line 36. Alternatively, as shown in dotted lines in FIG. 1, ozone may be introduced into liquid supplied to the chamber 10, through an ozone liquid injection line 38.

A process liquid, such as DI water, is supplied from a liquid source or reservoir 22. A heater 24 heats the liquid. The liquid moves (via gravity or pump) through a liquid supply line 26 to the chamber 10. Chemical additives, such as ammonium hydroxide, hydrochloric acid, or hydrofluoric acid may be introduced to the liquid from chemical additive sources or reservoirs 28, 30 and 32. A radiation source, such as a UV, IR, gamma, or x-ray emitter 40, may also be provided to introduce electromagnetic energy to the workpiece 20. The radiation source 40 may be inside the chamber 10, or outside of the chamber 10, so long as the radiation can pass into the chamber and be directed to the workpiece 20.

Referring still to FIG. 1, in use, heated process liquid and ozone are introduced into the chamber 10, with or without chemical additives. The heated liquid is applied to the workpiece surface, and forms a thin layer, or boundary layer of liquid on the wafer surface. The thickness of the boundary layer may be controlled by the liquid flow rate, by spinning the workpiece 20 with the motor 14, by controlled spraying, by use of surfactance, or by combinations of these techniques.

Sonic energy is introduced to the surface of the workpiece 20 by the sonic energy source or transducer 16. Various transducer designs and techniques may be used. The sonic energy source may be a generally flat, plate-like sonic transducer 16 on the workpiece holder 12, and in direct or indirect physical contact with the workpiece 20. An energy conductor, such as quartz, silicon, metal, or a polymer material, disk or sheet may be attached or bonded to the sonic transducer 16, with the workpiece 20 in direct physical contact with the energy conductor. Alternatively, the workpiece 20 may be in direct physical contact with the transducer 16. In the horizontal orientation schematically illustrated in FIG. 1, the transducer 16 may alternatively be placed into contact with the workpiece 20 through a layer of liquid maintained on the back or top surface of the workpiece 20. The transducer 16, which is in direct or indirect contact with the top or back side of the workpiece 20, introduces sonic energy to the back or top surface of the workpiece 20. The sonic energy acts on the workpiece 20 and assists in removing photoresist or other contaminant from the front or bottom surface of the workpiece 20. The sonic transducer 16 may also be used on a fixed workpiece holder 12 within the chamber 10 (i.e., without rotation of the work piece). Alternatively, the sonic transducer 16 may be mounted on or be part of a rotor, or a workpiece holder 12 which rotates within the chamber 10.

FIG. 1 schematically illustrates the wafer in a horizontal, face down position. However, the wafer and support may be oriented vertically or at any other angle or position. For example, the transducer 16 may be below the wafer 20.

FIG. 2 shows an alternative sonic energy assembly 50, for providing sonic energy to a front or back surface of the workpiece 20, along with the process liquid. As shown in FIG. 2, the sonic energy assembly 50 includes a sonic transducer 52 on or in a focus housing 54. Process liquid enters the focus housing 54 through a liquid inlet 58 and flows or sprays out through a nozzle 56. As the process liquid moves out of the focus housing 54, it forms a layer of liquid 42 on the workpiece 20.

In use, the focus housing 54 is filled with process liquid from the liquid source 22. The liquid provides a path for sonic energy from the transducer 52, through the liquid in the focus housing 54, through the boundary layer of liquid 42, to the surface of the workpiece 20.

The sonic energy assembly 50 shown in FIG. 2 focuses sonic energy from the transducer 52 onto a small area of the work piece. This design can provide an intense amount of sonic energy over a small area. To provide sonic energy to all areas of the workpiece surface, using the sonic energy assembly 50 shown in FIG. 2, the workpiece 20 is rotated, under or over the nozzle 56. In addition, the sonic energy source 50 is moved radially on a swing arm, or translating arm 57, between workpiece center and edge areas. The combination of workpiece rotation and sonic energy source radial or translational movement allows the nozzle 56 to introduce sonic energy sequentially to all locations on the surface of the workpiece 20.

Process liquid flows from the liquid inlet 58 through the focus housing 54 and onto the workpiece through the nozzle 56. This liquid supply may be the only process liquid supplied to the work piece. Alternatively, the sonic energy source 50 shown in FIG. 2 may be used in combination with other process liquid outlets or nozzles also providing process liquid onto the work piece. Alternatively, two or more of the sonic energy assemblies 50 may be used. The liquid is preferably de-ionized water. The liquid may optionally include or consist of ammonium hydroxide, an acid hydroxide, sulfuric acid, hydrochloric acid, hydrofluoric acid, ammonium fluoride, a surfactant, de-ionized water, or a combination of them.

FIG. 3 shows an alternative design having a fixed or moving sonic transducer and physical contact with the layer of liquid 42 on the surface of the workpiece 20. In this embodiment, the processed liquid is provided by an outlet or nozzle 62 separate from the sonic energy source 44.

The nozzle 54 may be vertically above or below the workpiece. The nozzle opening is preferably round. The nozzle diameter is small enough to create a solid column or jet of liquid moving out of the workpiece. The nozzle diameter and spacing between the nozzle and workpiece may vary with the liquid flow rate and pressure, and other parameters.

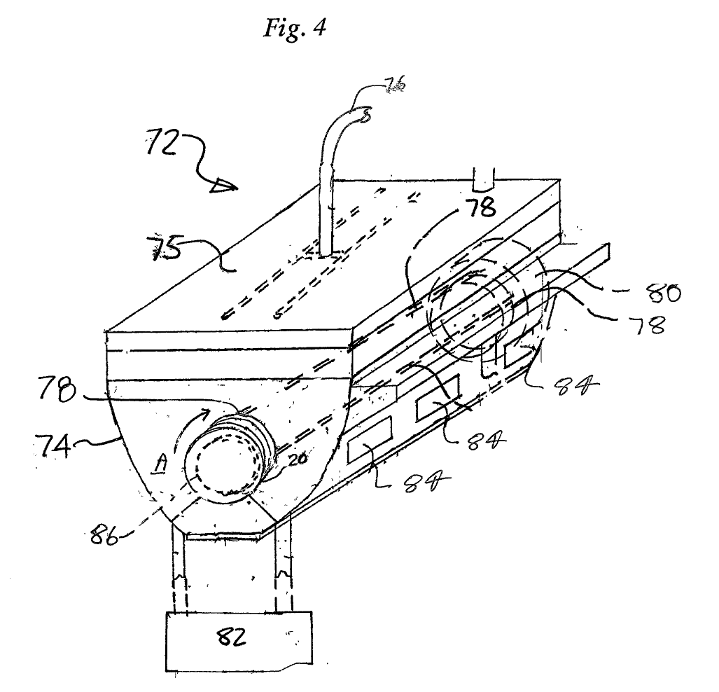

FIG. 4 shows an alternative system for processing work pieces using ozone and sonic energy. A workpiece support 78 supports work pieces or wafers 20 within a vessel or tank 74. One or more sonic transducers 84 are provided in or on the tank 74. A lid 75 closes off the open top surface of the tank 74. An ozone supply line 76 delivers ozone gas to the tank 74. A liquid supply system 82 delivers and removes process liquid into and out of the tank 74.

In use, at least one work piece, and preferably a batch or array or work pieces 20 are loaded onto the support 78. This step may occur while the support is within the tank 74, or by temporarily removing the support 78 from the tank 74, or raising it up out of the tank. The work pieces 20 are then at least partially immersed in process liquid. This may be achieved by placing the work pieces within the support 78 in the tank 74, and then introducing liquid into the tank, so that the level of liquid in the tank rises to partially or preferably fully immerse the work pieces 20. Alternatively, liquid may be introduced into the tank 74 in advance, with the work pieces in the support 78 lowered into the liquid. The liquid is preferably heated, DI water, with or without chemical additives, as described above with reference to FIG. 1.

Ozone is then introduced into the tank 74 from an ozone supply line 76, forming an ozone atmosphere above the surface of the liquid in the tank 74. Alternatively, the ozone atmosphere may be formed by ozone bubbles coming out of the liquid in the tank. The sonic transducers 84 are turned on. The work pieces 20 are then gradually lifted up out of the liquid into the ozone atmosphere. The gas/liquid interface moves down across the work pieces. Alternatively, this step may be performed by draining the liquid from the tank 74. As this occurs, the ozone liquid interface moves down across the surface of each wafer. The liquid at the interface, i.e., at the liquid interface is energized by the sonic energy supplied by the transducers 84. This combination of the ozone atmosphere and sonic energy improves removal of contaminants.

The lid 75 is provided on the tank 74 to confine the ozone atmosphere within the tank. The lid need not necessarily form a pressure type seal with the tank. However, in an alternative embodiment, the lid 75 forms a pressure type seal with the tank 74, and the gas pressure in the space above the liquid level is increased, to provide for higher gas pressure processing.

The workpiece support 78 may be fixed in place within the tank 74. In this design, the work pieces 74 are lowered onto the support 78 in the tank 74, either manually or via a robot. The work pieces 20 remain in place during processing. Alternatively, the support 78 may form a rotor attached to a rotation motor 80. In this design, the work pieces 20 may be rotated, e.g., in the direction of the arrow A in FIG. 4, during processing, or after the liquid is removed. The workpiece support 78 may include elevators or lifters, for raising and lowering the support 78 into and out of the tank 74, to facilitate loading and unloading of work pieces, and to implement the step of moving the work pieces out of the liquid.

In addition to the tank sonic transducers 84, or in place of them, one or more sonic transducers 86 may be provided on the workpiece support 78. The sonic transducers 86 need not be in physical contact with the work pieces 20, because the liquid in the tank 74 acts as a sonic energy transmission media during processing.

Thus, novel methods and apparatus have been shown and described. Various modifications and substitutions may, of course, be made without departing from the spirit and scope of the invention. The invention, therefore, should not be limited, except by the following claims and they are equivalents.

What is claimed:

1. An apparatus for processing a workpiece comprising:
a liquid supply source;
one or more liquid outlets disposed to apply liquid onto the workpiece;
a liquid flow line extending between the liquid supply source and the one or more liquid outlets for carrying liquid to the liquid outlets;
at least one heater for heating the liquid before it is applied onto the workpiece;
an ozone gas supply system which provides ozone gas around the workpiece; and
a sonic energy source for introducing sonic energy to the workpiece.

2. The apparatus of claim 1 further comprising a sonic energy conductor in contact with the sonic energy source and in contact with the sonic energy source.

3. The apparatus of claim 2 wherein the sonic energy conductor comprises quartz, silicon, metal or a polymer.

4. The apparatus of claim 1 with the sonic energy source associated with the liquid outlets, to provide sonic energy to the workpiece via liquid moving out of the outlets and onto the workpiece.

5. The apparatus of claim 1 wherein the sonic energy source comprises a sonic transducer including a focusing chamber for concentrating sonic energy onto the workpiece.

6. The apparatus of claim 1 where the liquid supply source comprises a liquid reservoir, and where the heater heats the liquid in the reservoir.

7. The apparatus of claim 1 where the liquid supply source includes a liquid selected from the group consisting of, ammonium hydroxide, sulfuric acid, hydrochloric acid, hydrofluoric acid, a surfactant, de-ionized water, and a combination thereof.

8. The apparatus of claim 1 further comprising a chamber around the workpiece and with the ozone gas supply connected to the chamber to provide ozone gas around the workpiece in the chamber, with the ozone provided as a dry gas or in a liquid.

9. The apparatus of claim 8 further comprising a re-circulation liquid line extending between the chamber and the liquid supply source.

10. The apparatus of claim 8 further comprising a rotor assembly in the chamber for rotating the workpiece.

11. The apparatus of claim 1 where the liquid outlets comprise liquid nozzles for spraying the heated liquid onto the workpiece.

12. The apparatus of claim 1 further including means for controlling the thickness of a layer of the liquid formed on the surface of the workpiece.

13. The apparatus of claim 12 where the means for controlling comprises a liquid flow control system for controlling the flow of liquid onto the workpiece.

14. The apparatus of claim 13 where the liquid flow control system includes spray nozzles.

15. The apparatus of claim 12 where the means for controlling comprises a rotor for holding and rotating the workpiece.

16. An apparatus for treating the surface of a workpiece comprising:
a liquid reservoir for holding a process liquid;
a process chamber;
a workpiece holder within the process chamber;
liquid spray nozzles within the process chamber disposed to spray liquid onto the workpiece held by the workpiece holder;
a liquid flow line extending between the liquid reservoir and the liquid spray nozzles;
an ozone generator for generating a supply of ozone;
one or more ozone supply lines extending from the ozone generator to the process chamber;
at least one heater for heating the process liquid; and
a sonic energy source on the workpiece holder for introducing sonic energy to the workpiece.

17. The system of claim 16 where the workpiece support holds the workpiece in a horizontal orientation.

18. The system of claim 16 further comprising a valve connecting to a spent liquid line extending from the process chamber, to the liquid reservoir, and to a drain, with the valve switchable between a first position, wherein spent liquid from the process chamber is directed back to the reservoir, and a second position, wherein spent liquid from the process chamber is directed to the drain.

19. A method for processing a workpiece, comprising the steps of:
positioning the workpiece at least partially within a bath of liquid;
creating an ozone atmosphere above the surface of the bath of liquid;
applying sonic energy to the bath of liquid;
moving at least one of the workpiece and the surface of the bath of liquid, to cause the surface of the liquid to move across the workpiece surface.

20. The method of claim 19 wherein the workpiece is positioned within the bath of liquid by lowering the workpiece into the bath.

21. The method of claim 19 wherein the workpiece is positioned within the bath by raising the surface of the liquid.

22. The method of claim 19 with the workpiece fully submerged in the liquid, while sonic energy is applied.

23. The method of claim 19 further comprising heating the liquid to a temperature above ambient.

24. The method of claim 19 further comprising positioning the workpiece in a second bath, removing the workpiece from the second bath, and drying the workpiece.

25. The method of claim 19 where the liquid comprises water.

26. The method of claim 25 with the liquid further comprising a member selected from the group consisting of HF, HCl, NH₄(OH), NH₄F.

27. The method of claim 19 where the ozone atmosphere is created above the surface of the liquid by injecting ozone gas above the surface of the liquid.

28. The method of claim 19 where the ozone atmosphere is created above the liquid surface by bubbling ozone through the liquid.
